(19) United States
(12) Patent Application Publication
(10) Pub. No.: US 2014/0095128 A1
(43) Pub. Date: Apr. 3, 2014

(54) METHOD OF PREDICTING DNA 3D STRUCTURE BASED ON PRIMARY DNA SEQUENCE

(71) Applicant: Samsung Electronics Co., Ltd., Suwon-si (KR)

(72) Inventor: Misook HA, Hwaseong-si (KR)

(73) Assignee: Samsung Electronics Co., Ltd., Suwon-si (KR)

(21) Appl. No.: 14/039,577

(22) Filed: Sep. 27, 2013

(30) Foreign Application Priority Data
Sep. 28, 2012 (KR) 10-2012-0109404

(51) Int. Cl. G06F 19/16; G06F 19/12

(52) U.S. Cl. CPC G06F 19/16; G06F 19/12
USPC 703/2; 703/11

(57) ABSTRACT

Provided is a method of predicting a DNA structure by predicting the distribution of a nucleosome in a DNA sequence using a specificity of a nucleosome, and a method of determining a position of a nucleosome in DNA sequence by predicting the position using a specificity of a nucleosome.

### CROSS-REFERENCE TO RELATED APPLICATION

This application claims the benefit under 35 U.S.C. §119(a) of Korean Patent Application No. 10-2012-0109404 filed on Sep. 28, 2012, in the Korean Intellectual Property Office, the entire disclosure of which is incorporated herein by reference for all purposes.

### BACKGROUND

1. Field

The following description relates to a method of predicting a DNA structure and a method of determining a position of a nucleosome using a primary DNA sequence.

2. Description of the Related Art

Genomic DNA may be classified into a gene and a regulating factor that regulates the gene expression. Chromatin is the genetic material which makes up the content of a cell nucleus. Chromatin includes a combination of DNA and protein, and the basic structure of chromatin is a nucleosome which consists of 147 base pairs (bps) of DNA and 8 histone proteins. The arrangement of nucleosomes and the chemical modification of histone proteins within chromatin determine the 3D structure of DNA.

Recently, it has been discovered that the 3D structure of DNA is an important mechanism that regulates gene expression. Further, it has been discovered that the 3D structure of DNA has a fundamental effect on human diseases. Accordingly, medical application studies have been actively conducted for studying 3D structures of DNA and their effect on diseases.

As it has become more possible to measure chromatin structure of an entire human genome due to the development of chromatin immunoprecipitation sequencing (ChIP-seq) technology, the verification of the study's results have been facilitated and the possibility of practical applications in the medical industry has increased.

However, the associative relationship between the 3D structure of DNA and its primary sequence is not well understood. Additionally, an approach for inferring or determining the 3D structure of DNA from its primary DNA base sequence is not known.

### SUMMARY

In a general aspect, there is provided a method of predicting DNA structure, the method including obtaining a specificity of a nucleosome; and predicting a distribution of the nucleosome in a DNA sequence using the obtained specificity.

The method may further include predicting a DNA 3D structure using a primary DNA sequence; and the obtaining may include obtaining the specificity of the nucleosome where the nucleosome comprises a histone modification and the specificity is associated with the histone modification.

The specificity may be a sequence preference for a preferred DNA sequence by the nucleosome where the preferred DNA sequence is distinct from other DNA sequences of other nucleosomes not comprising the histone modification; and the specificity may be consistently found in other types of cells for nucleosomes of a same type as the nucleosome.

The obtaining may further include obtaining specificities of nucleosomes in which histone modifications occur or do not occur.

The predicting may include calculating a probability that each position of the DNA sequence is included in a DNA sequence of the nucleosome; and the probability of each of the base pairs may be calculated using effects of adjacent DNA sequences and adjacent nucleosomes.

The predicting may include using a hidden Markov model which takes into consideration the effects of the adjacent DNA sequences and the adjacent nucleosomes.

The obtaining may further include obtaining specificities of an H3K4me3 nucleosome and an H3 nucleosome.

The DNA sequence may be a 6mers sequence.

The specificity may be obtained from data acquired by any one or any combination of chromatin immunoprecipitation sequencing (ChIP-seq), chromatin immunoprecipitation with microarray technology (ChIP-chip), and chromatin immuniprecipitation (ChIP).

The hidden Markov model may include nodes N1 to N147 referring to a probability that a base pair is a first base pair to a 147^{th} base pair of a first nucleosome, and nodes M1 to M147 referring to a probability that the base pair is a first base pair to a 147^{th} base pair of a second nucleosome.

The predicting may include determining regions of the DNA sequence which are not occupied by histones and a ratio of regions that are not occupied by histones to regions that are occupied by histones.

The predicting may include determining a probability that the DNA sequence is not occupied by a first nucleosome or a second nucleosome, a probability that the DNA sequence is occupied by the first nucleosome, and a probability that the DNA sequence is occupied by the second nucleosome.

The first nucleosome may be an H3K4me3 nucleosome and the second nucleosome may be an H3 nucleosome.

In another general aspect, there is provided a non-transitory computer-readable storage medium storing a program, comprising instructions for causing a computer to perform the method.

In another general aspect, there is provided a method of determining a position of a nucleosome in a DNA sequence, the method including obtaining a specificity of the nucleosome; and predicting the position of the nucleosome using the obtained specificity.

The predicting the position of the nucleosome may be used for predicting a 3D structure of the DNA sequence.

The predicting the position of the nucleosome may include using a hidden Markov model which takes into consideration effects of an adjacent DNA sequence and an adjacent nucleosome.

### BRIEF DESCRIPTION OF THE DRAWINGS

FIG. 1 is a flowchart illustrating an example of a method of predicting a 3D structure based on a primary DNA sequence.

FIGS. 2A, 2B, and 2C are diagrams illustrating examples of sequence specificities of an H3K4me3 nucleosome in various types of human cells.

FIG. 3 is a diagram illustrating an example of a prediction model for predicting whether each base pair of genome base sequences is included in the base sequence of a specific nucleosome using a hidden Markov model,

FIGS. 4A and 4B are diagrams illustrating examples of results that compare a DNA 3D structure which is predicted by the prediction model with values derived from actual experiments.

FIG. 5 is a diagram illustrating examples of results that compare a probability of the H3K4me3 nucleosome as predicted by the prediction model in various types of cells with experimental values.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the present specification, an H3K4me3 nucleosome refers to a nucleosome in which the fourth lysine from the N-end of an H3 histone is trimethylated. Also, an H3 nucleosome refers to a nucleosome in which a modification does not occur in H3.

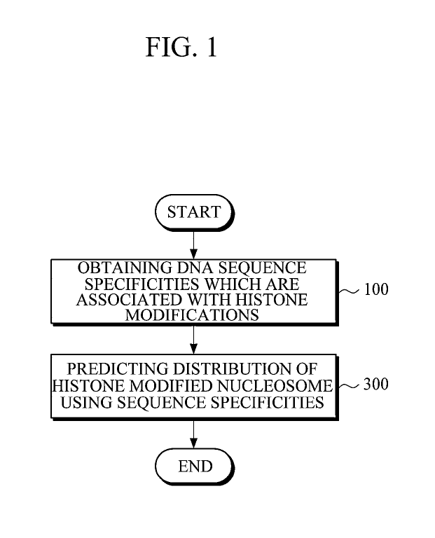

FIG. 1 is a flowchart illustrating an example of a method of predicting a 3D structure of DNA based on a primary DNA sequence. Although this example describes a method of predicting a 3D structure, in other examples, a 2D structure of DNA may also be predicted.

Referring to FIG. 1, a method of predicting a 3D structure based on a primary DNA sequence includes obtaining DNA sequence specificities of a nucleosome, the specificities being associated with histone modifications (100). The method also includes predicting a distribution of a nucleosome in which the histone modifications occur using the obtained DNA sequence specificities (300). This predicting may be done for any DNA sequence and any nucleosome exhibiting any type of histone modification or not exhibiting histone modification.

DNA sequence specificities refer to characteristics of a DNA sequence for a DNA sequence which is associated with a nucleosome having a histone with histone modifications. The DNA specificities of the sequences associated with histone modified nucleosomes are distinct from the characteristics of other DNA sequences of nucleosomes where histone modification does not occur. Further, these DNA specificities are consistently present among a particular DNA sequence even in different types of cells.

The sequence specificities associated with histone modifications may be obtained from data acquired by chromatin immunoprecipitation sequencing (ChIP-seq), chromatin immunoprecipitation with microarray technology (ChIP-chip), Chromatin immunoprecipitation (ChIP), and/or data acquired by other sequencing methods.

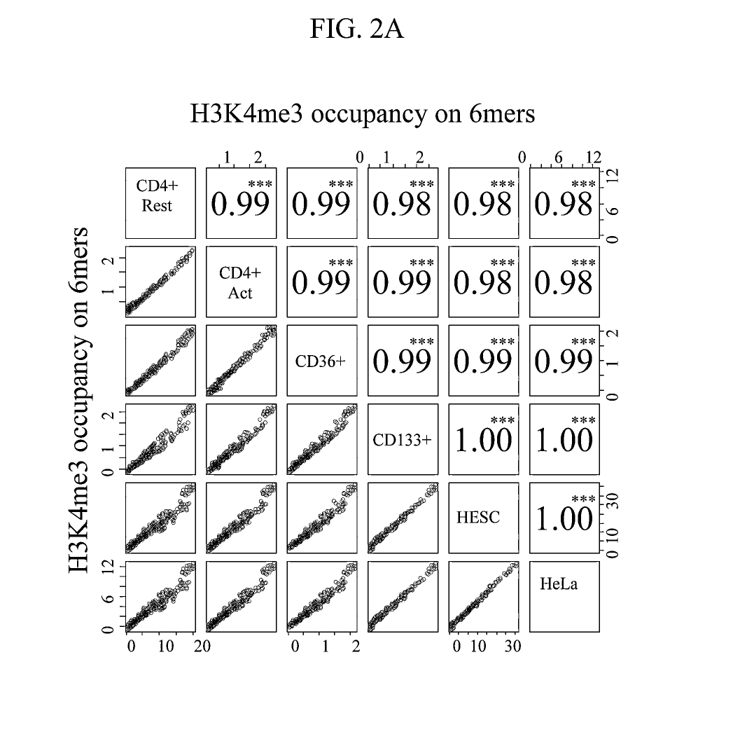

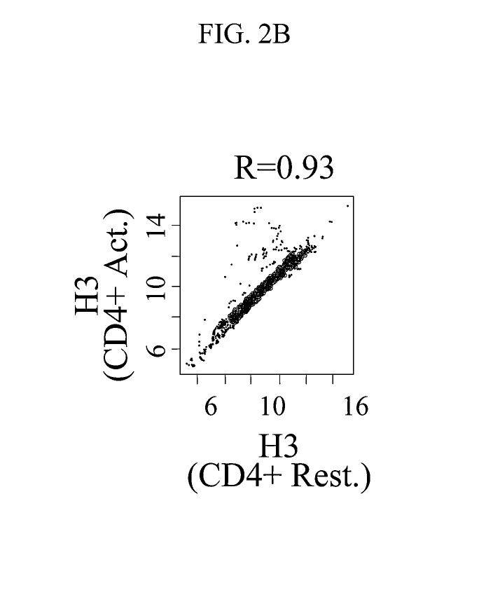

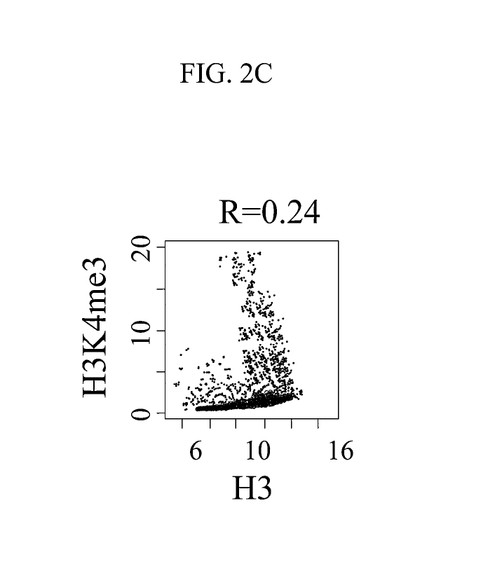

FIGS. 2A, 2B, and 2C are diagrams illustrating examples of sequence specificities of an H3K4me3 nucleosome in various types of human cells.

Referring to FIG. 2A, the diagonal axis which is in the center of the graph indicates the cell types related to the data in the X-axis and Y-axis. The numbers which are in the squares (top right of graph) denote the correlation coefficients associated with the occupancy of a DNA sequence (in this example the 6mer sequence) for a particular histone (in this example the H3K4me3 histone) between two cell types. For example, the graph indicates that the correlation coefficient of the 6mer sequence occupancy for the H3K4me3 histone in the CD4+ T cell in an activated state and the HESC cell is 0.98.

In this example, each point corresponds to the enrichment of 6mer in two forms of cells in the ChIP-seq experiment. The horizontal and vertical axes denote the number of reads from the ChIp-seq experiment including the 6mer as normalized by the number of 6mers in a human genome.

Still referring to FIG. 2A, it can be seen that there is a strong correlation between the frequencies at which all possible 6mer sequences are found in the H3K4me3 nucleosome among the various types of human cells. The correlation data may be obtained by data acquired by the Chip-seq experiment. Alternatively, the correlation data may be obtained from data acquired by other methods for analyzing DNA-Protein interactions.

Referring to FIG. 2B, it can be seen that for a CD4+ T cell in an activated state and a CD4+ T cell in a resting state, the correlation coefficient for sequence occupancy with respect to the H3 nucleosome is 0.93, indicating a very high correlation.

Conversely, referring to FIG. 2C, it can be seen that the correlation coefficient for sequence preference of the H3K4me3 nucleosome and the H3 nucleosome in the same cell is 0.24, indicating a low correlation.

Through FIGS. 2A to 2C, it can be seen that the H3K4me3 nucleosome shows a preference for the sequence combination of 6mers that is different from other nucleosomes, and that this preference is exhibited consistently throughout various types of cells. Accordingly, the preference of the H3K4me3 nucleosome for the 6mers sequence combination may be utilized as a sequence specificity which is used in a probability model for obtaining the distribution of the H3K4me3 nucleosome in a genome sequence.

Further, as confirmed through the ChIP-seq experiment, the H3 nucleosome is distinct from other nucleosomes and has sequence specificities and preferences that are consistently exhibited even in different types of cells.

In this example, a model that estimates the distribution of the H3K4me3 nucleosome will be described using the sequence specificities of the H3K4me3 nucleosome and the H3 nucleosome. However, in alternative examples, the estimation model may be produced using the sequence specificities of other histone-modified nucleosomes or unmodified nucleosomes without being limited to the sequence specificities of the H3K4me3 nucleosome and the H3 nucleosome.

It is possible to obtain a probability P(H3K4me3|S) that any base sequence (S) is included in the H3K4me3 nucleosome and a probability P(H3|S) that any base sequence (S) is included in the H3 nucleosome using the sequence specificities which have been obtained for the H3K4me3 nucleosome and the H3 nucleosome, respectively (300).

The position of each base sequence may be occupied by only one nucleosome. Thus, possible arrangements of a nucleosome need to be considered at each position of the genome base sequence. Therefore, in this example, the probability that the specific position of a base sequence is occupied by the H3K4me3 nucleosome or the H3 nucleosome is obtained by considering the effects of adjacent base sequences or adjacent nucleosomes.

In an example, the distribution of the H3 nucleosome and the H3K4me3 nucleosome may be predicted for a genome sequence by using a hidden Markov model. In this example, the hidden Markov model considers sequences which precede and follow a specific position of the genome base sequence.

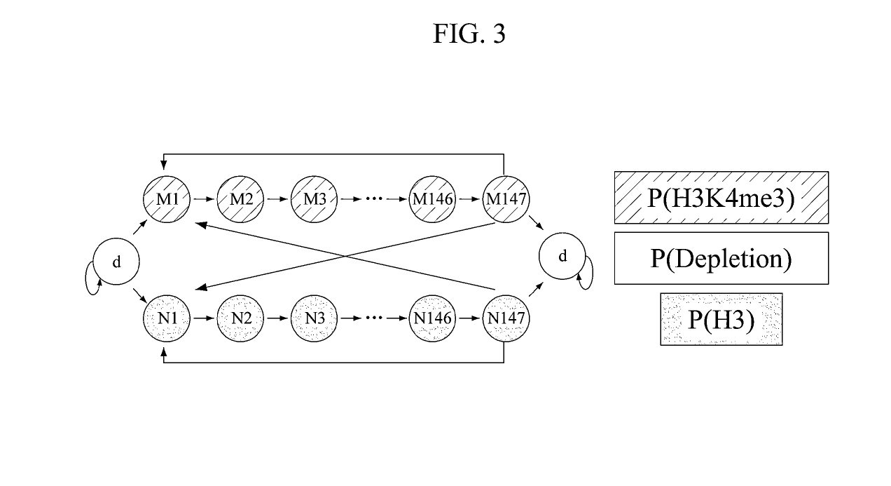

FIG. 3 is a diagram illustrating an example of a prediction model for predicting whether each base pair of a genome base sequence is included in the base sequence of a specific nucleosome using a hidden Markov model.

Referring to the example of FIG. 3, nodes M1 to M147 refer to the probability that a specific base-pair is the first base-pair to the 147th base-pair in the H3K4me3 nucleosome base sequence. Additionally, nodes N1 to N147 refer to the probability that the specific base-pair is the first base-pair to the 147th base-pair of the H3 nucleosome base sequence. The node d refers to the probability that the specific base-pair does not belong to the base sequence of the H3K4me3 nucleosome or the H3 nucleosome.

Considering the preceding base sequence of the specific base-pair of the given base sequence, the probability that the specific base-pair belongs to the H3K4me3 nucleosome or the H3 nucleosome may be derived as follows.

α₁(d)=π_{d}P_{d}(S₁) [Equation 1]

Equation 1 refers to the probability that the sequence of S1 is found and that S1 is not occupied by the H3 or the H3K4me3 nucleosome. In this equation, d refers to a region that is not occupied by a histone protein in the genome sequence, and πd refers to the ratio of regions that are not occupied by a histone protein.

Meanwhile, the base sequences from S1 to St are found in the genome base sequence using Equations 2 to 14. Referring to Equations 2 to 14, it is possible to obtain the probability αt(Mi) that St is the i-th base sequence of the H3K4me3 nucleosome, the probability αt(Ni) that St is the i-th base sequence of the H3 nucleosome, and the probability αt(d) that St does not belong to the base sequence of the H3 nucleosome or the H3K4me3 nucleosome, respectively.

αₜ(d)=π_{d}P_{d}(Sₜ){αₜ₋₁(d)+αₜ₋₁(N₁₄₇)+αₜ₋₁(M₁₄₇)} [Equation 2]

αₜ(M₁)=π_{M}P_{M}(Sₜ){αₜ₋₁(d)+αₜ₋₁(N₁₄₇)+αₜ₋₁(M₁₄₇)} [Equation 3]

αₜ(M₂)=αₜ₋₁(M₁)P_{M}(Sₜ|Sₜ₋₁) [Equation 4]

αₜ(M₃)=αₜ₋₁(M₂)P_{M}(Sₜ|Sₜ₋₂, Sₜ₋₁) [Equation 5]

α_{τ}(M₄)=αₜ₋₁(M₃)P_{M}(Sₜ|Sₜ₋₃, Sₜ₋₂, Sₜ₋₁) [Equation 6]

α_{τ}(M₅)=αₜ₋₁(M₄)P_{M}(Sₜ|Sₜ₋₄, Sₜ₋₃, Sₜ₋₂, Sₜ₋₁) [Equation 7]

α_{τ}(Mᵢ)=αₜ₋₁(Mᵢ₋₁)P_{M}(Sₜ|Sₜ₋₅, Sₜ₋₄, Sₜ₋₃, Sₜ₋₂, Sₜ₋₁), 6≦i≦147 [Equation 8]

α_{τ}(N₁)=π_{N}P_{N}(Sₜ){αₜ₋₁(d)+αₜ₋₁(N₁₄₇)+αₜ₋₁(M₁₄₇)} [Equation 9]

α_{τ}(N₂)=αₜ₋₁(N₁)P_{N}(Sₜ|Sₜ₋₁) [Equation 10]

α_{τ}(N₃)=αₜ₋₁(N₂)P_{N}(Sₜ|Sₜ₋₂, Sₜ₋₁) [Equation 11]

α_{τ}(N₄)=αₜ₋₁(N₃)P_{N}(Sₜ|Sₜ₋₃, Sₜ₋₂, Sₜ₋₁) [Equation 12]

α_{τ}(N₅)=αₜ₋₁(N₄)P_{M}(Sₜ|Sₜ₋₄, Sₜ₋₃, Sₜ₋₂, Sₜ₋₁) [Equation 13]

αₜ(Nᵢ)=αₜ₋₁(Nᵢ₋₁)P_{N}(Sₜ|Sₜ₋₅, Sₜ₋₄, Sₜ₋₃, Sₜ₋₂, Sₜ₋₁), 6≦i≦147 [Equation 14]

From each probability obtained from Equations 2 to 14, it is possible to obtain a state probability at the i-th position of the genome base sequence in which the genome base sequences from the first base pair S1 to Si are considered. In this example, Equation 15 is used for determining a state probability for the i-th position using the base sequence probabilities of equations 2 to 14.

$$P ( {S}_{1} , … , {S}_{T} \vert Model ) = {α}_{T} ( d ) + [ {\sum }_{i = 1}^{147} {α}_{T} ( {M}_{i} ) + {\sum }_{i = 1}^{147} {α}_{T} ( {N}_{i} ) ] \qquad [ Equation 15 ]$$

In this equation, T refers to the total length of the genome.

Further, from Equations 17 to 31, it is possible to obtain the probability βt(Mi) of the sequence from St+1 to the end of the genome sequence at St=Mi, the probability βt(Ni) of the sequence from St+1 to the end of the genome sequence at St=Ni, and the probability βt(d) of the sequence from St+1 to the end of the genome sequence at St=d, respectively.

The initial condition is the same as is shown in Equation 16.

β_{T}(d)=β_{T}(Mᵢ)=β_{T}(Nᵢ)=1, 1≦i≦147, [Equation 16]

In this equation, T refers to the length of the genome.

βₜ(d)=π_{d}P_{d}(Sₜ₊₁)βₜ₊₁(d)+π_{N}P_{N}(Sₜ₊₁)βₜ₊₁(N₁)+π_{M}P_{M}(Sₜ₊₁)βₜ₊₁(M₁) [Equation 17]

βₜ(Mᵢ)=βₜ₊₁(Mᵢ₊₁)P_{M}(Sₜ₊₁|Sₜ₊₂, Sₜ₊₃, Sₜ₊₄, Sₜ₊₅, Sₜ₊₆), 1≦i≦141 [Equation 18]

βₜ(M₁₄₂)=βₜ₊₁(M₁₄₃)P_{M}(Sₜ₊₁|Sₜ₊₂, Sₜ₊₃, Sₜ₊₄, Sₜ₊₅) [Equation 19]

βₜ(M₁₄₃)=βₜ₊₁(M₁₄₄)P_{M}(Sₜ₊₁|Sₜ₊₂, Sₜ₊₃, Sₜ₊₄) [Equation 20]

βₜ(M₁₄₄)=βₜ₊₁(M₁₄₅)P_{M}(Sₜ₊₁|Sₜ₊₂, Sₜ₊₃) [Equation 21]

βₜ(M₁₄₅)=βₜ₊₁(M₁₄₆)P_{M}(Sₜ₊₁|Sₜ₊₂) [Equation 22]

βₜ(M₁₄₆)=βₜ₊₁(M₁₄₇)P_{M}(Sₜ₊₁) [Equation 23]

βₜ(M₁₄₇)=π_{d}P_{d}(Sₜ₊₁)βₜ₊₁(d)+π_{N}P_{N}(Sₜ₊₁)βₜ₊₁(N₁)+π_{M}P_{M}(Sₜ₊₁)βₜ₊₁(M₁) [Equation 24]

βₜ(Nᵢ)=βₜ₊₁(Nᵢ₊₁)P_{N}(Sₜ₊₁|Sₜ₊₂, Sₜ₊₃, Sₜ₊₄, Sₜ₊₅, Sₜ₊₆), 1≦i≦141 [Equation 25]

βₜ(N₁₄₂)=βₜ₊₁(N₁₄₃)P_{N}(Sₜ₊₁|Sₜ₊₂, Sₜ₊₃, Sₜ₊₄, Sₜ₊₅) [Equation 26]

βₜ(N₁₄₃)=βₜ₊₁(N₁₄₄)P(Sₜ₊₁|Sₜ₊₂, Sₜ₊₃, Sₜ₊₄) [Equation 27]

βₜ(N₁₄₄)=βₜ₊₁(N₁₄₅)P_{N}(Sₜ₊₁|Sₜ₊₂, Sₜ₊₃) [Equation 28]

βₜ(N₁₄₅)=βₜ₊₁(N₁₄₆)P(Sₜ₊₁|Sₜ₊₂) [Equation 29]

βₜ(N₁₄₆)=βₜ₊₁(N₁₄₇)P_{N}(Sₜ₊₁) [Equation 30]

βₜ(N₁₄₇)=π_{d}P_{d}(Sₜ₊₁)βₜ₊₁(d)+π_{N}P_{N}(Sₜ₊₁)βₜ₊₁(N₁)+π_{M}P_{M}(Sₜ₊₁)βₜ₊₁(M₁) [Equation 31]

Meanwhile, the probability that the t-th base pair in the genome base sequence is located at Mi may be normalized as shown in Equation 32.

$$P ( {S}_{t} = {M}_{i} \vert {S}_{1} , … , {S}_{T} , model ) = \frac{{α}_{t} ( {M}_{i} ) {β}_{t} ( {M}_{i} )}{{α}_{t} ( d ) {β}_{t} ( d ) + {\sum }_{i = 1}^{147} [ {α}_{t} ( {N}_{i} ) {β}_{t} ( {N}_{i} ) + {α}_{t} ( {M}_{i} ) {β}_{t} ( {M}_{i} ) ]} \qquad [ Equation 32 ]$$

As a result, it is possible to derive the probabilities that any base pair position of the genome sequence belongs to the base sequence of the H3K4me3 nucleosome and to the base sequence of the H3 nucleosome. This is derivation is shown in Equations 33 and 34.

$$\begin{matrix}P ( {S}_{t} is covered by H 3 K 4 me 3 ) = {\sum }_{i = 1}^{147} P ( {S}_{t} = {M}_{i} \vert {S}_{1} , … , {S}_{T} , model ) = \frac{{\sum }_{i = 1}^{147} {α}_{t} ( {M}_{i } ) {β}_{t} ( {M}_{i} )}{{α}_{t} ( d ) {β}_{t} ( d ) + {\sum }_{i = 1}^{147} [ {α}_{t} ( {N}_{i} ) {β}_{t} ( {N}_{i} ) + {α}_{t} ( {M}_{i} ) {β}_{t} ( {M}_{i} ) ]} & [ Equation 33 ] \\ P ( {S}_{t} is covered by H 3 ) = {\sum }_{i = 1}^{147} P ( {S}_{t} = {N}_{i} \vert {S}_{1} , … , {S}_{T} , model ) = \frac{{\sum }_{i = 1}^{147} {α}_{t} ( {N}_{i } ) {β}_{t} ( {N}_{i} )}{{α}_{t} ( d ) {β}_{t} ( d ) + {\sum }_{i = 1}^{147} [ {α}_{t} ( {N}_{i} ) {β}_{t} ( {N}_{i} ) + {α}_{t} ( {M}_{i} ) {β}_{t} ( {M}_{i} ) ]} & [ Equation 34 ]\end{matrix}$$

Accordingly, the distribution of H3K4me3 may be predicted by the prediction model as described above.

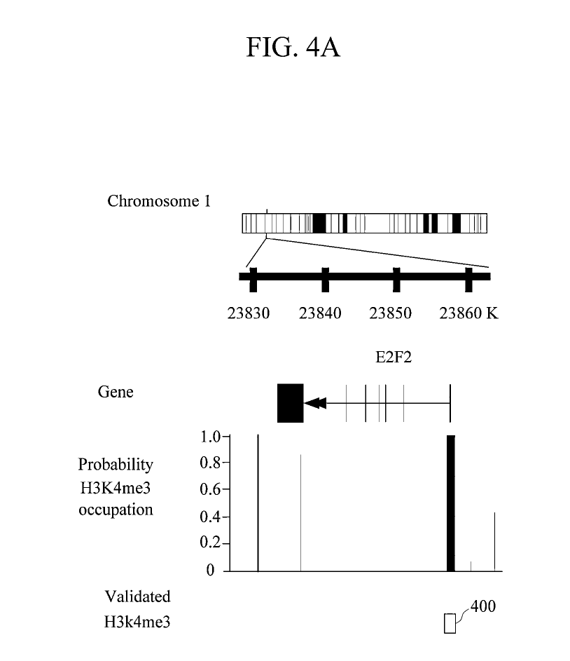

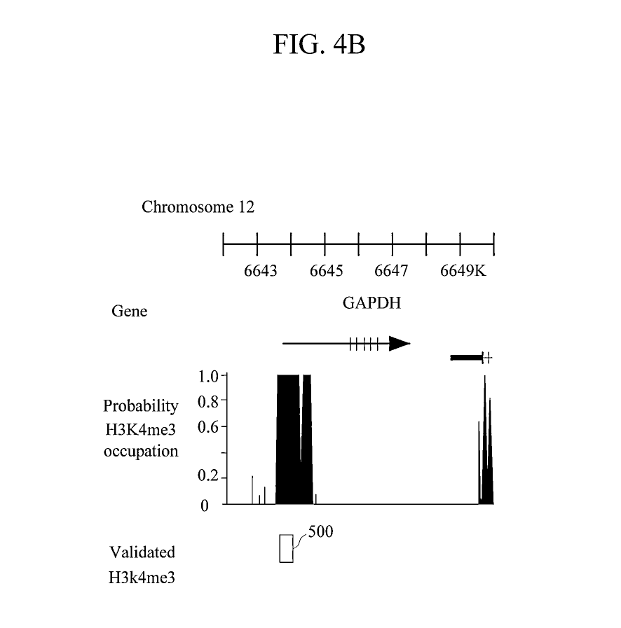

FIGS. 4A and 4B are diagrams illustrating examples of the results that compare a DNA 3D structure which is predicted by the prediction model with values derived from actual experiments.

The arrow in FIGS. 4A and 4B denotes the transcription direction, and the height of the black bar denotes the probability that the H3K4me3 nucleosome is occupied in the base-pair. Referring to FIGS. 4A and 4B, it can be seen that the occupancy position 400 of the H3K4me3 nucleosome as predicted by the probability model at the 5′ end of the E2F2 gene and the occupancy position 500 of the H3K4me3 nucleosome as predicted by the probability model at the 5′ end of the GAPDH gene almost coincide with the positions of the H3K4me3 nucleosome as confirmed by an actual experiment.

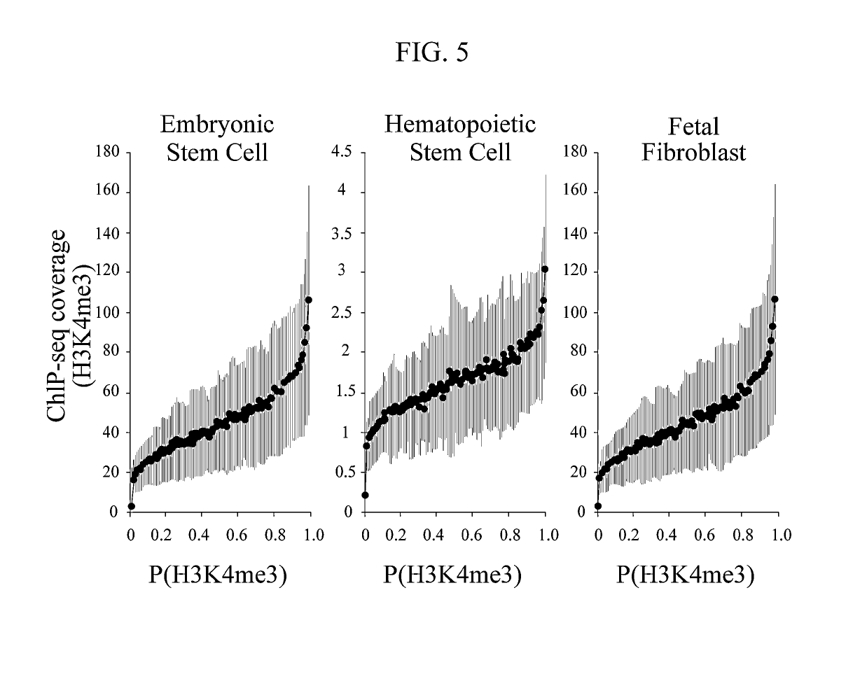

FIG. 5 is a diagram illustrating examples of results that compare the probability of the H3K4me3 nucleosome as predicted by the prediction model in various types of cells with experimental values.

Referring to FIG. 5, it can be seen that the probability of H3K4me3 occupancy in a human embryonic stem cell (HESC), a hematopoietic stem cell, and a fibroblast, as derived by the probability model, strongly correlates with the results of H3K4me3 nucleosome occupancy as derived by the Chip-seq experiment. Accordingly, in various aspects there is provided an accurate method of predicting histone occupancy and the 3D structure of DNA.

The apparatuses, methods, and units described above may be implemented using one or more hardware components, or a combination of one or more hardware components and one or more software components. A hardware component may be, for example, a physical device that physically performs one or more operations, but is not limited thereto. Examples of hardware components include controllers, microphones, amplifiers, low-pass filters, high-pass filters, band-pass filters, analog-to-digital converters, digital-to-analog converters, and processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

Software or instructions for controlling a processing device, such as those described in FIGS. 1 and 3, to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of predicting DNA structure, the method comprising:
obtaining a specificity of a nucleosome; and
predicting a distribution of the nucleosome in a DNA sequence using the obtained specificity.

2. The method of claim 1, wherein
the method further comprises predicting a DNA 3D structure using a primary DNA sequence; and
the obtaining comprises obtaining the specificity of the nucleosome where the nucleosome comprises a histone modification and the specificity is associated with the histone modification.

3. The method of claim 2, wherein
the specificity is a sequence preference for a preferred DNA sequence by the nucleosome where the preferred DNA sequence is distinct from other DNA sequences of other nucleosomes not comprising the histone modification; and
the specificity is consistently found in other types of cells for nucleosomes of a same type as the nucleosome.

4. The method of claim 1, wherein the obtaining further comprises obtaining specificities of nucleosomes in which histone modifications occur or do not occur.

5. The method of claim 4, wherein
the predicting comprises calculating a probability that each position of the DNA sequence is included in a DNA sequence of the nucleosome; and
the probability of each of the base pairs is calculated using effects of adjacent DNA sequences and adjacent nucleosomes.

6. The method of claim 5, wherein the predicting comprises using a hidden Markov model which takes into consideration the effects of the adjacent DNA sequences and the adjacent nucleosomes.

7. The method of claim 1, wherein the obtaining further comprises obtaining specificities of an H3K4me3 nucleosome and an H3 nucleosome.

8. The method of claim 1, wherein the DNA sequence is a 6mers sequence.

9. The method of claim 1, wherein the specificity is obtained from data acquired by any one or any combination of chromatin immunoprecipitation sequencing (ChIP-seq), chromatin immunoprecipitation with microarray technology (ChIP-chip), and chromatin immuniprecipitation (ChIP).

10. The method of claim 6, wherein the hidden Markov model comprises nodes N1 to N147 referring to a probability that a base pair is a first base pair to a 147^{th} base pair of a first nucleosome, and nodes M1 to M147 referring to a probability that the base pair is a first base pair to a 147^{th} base pair of a second nucleosome.

11. The method of claim 6, wherein the predicting comprises determining regions of the DNA sequence which are not occupied by histones and a ratio of regions that are not occupied by histones to regions that are occupied by histones.

12. The method of claim 6, wherein the predicting comprises determining a probability that the DNA sequence is not occupied by a first nucleosome or a second nucleosome, a probability that the DNA sequence is occupied by the first nucleosome, and a probability that the DNA sequence is occupied by the second nucleosome.

13. The method of claim 12, wherein the first nucleosome is an H3K4me3 nucleosome and the second nucleosome is an H3 nucleosome.

14. A non-transitory computer-readable storage medium storing a program, comprising instructions for causing a computer to perform the method of claim 1.

15. A method of determining a position of a nucleosome in a DNA sequence, the method comprising:
obtaining a specificity of the nucleosome; and
predicting the position of the nucleosome using the obtained specificity.

16. The method of claim 15, wherein the predicting the position of the nucleosome is used for predicting a 3D structure of the DNA sequence.

17. The method of claim 15, wherein the predicting the position of the nucleosome comprises using a hidden Markov model which takes into consideration effects of an adjacent DNA sequence and an adjacent nucleosome.
